(19) United States
(12) Patent Application Publication
(10) Pub. No.: US 2021/0261116 A1
(43) Pub. Date: Aug. 26, 2021

(54) INFORMATION PROCESSING DEVICE AND DRIVING ASSISTANCE DEVICE

(71) Applicant: DENSO CORPORATION, Kariya-city (JP)

(72) Inventors: Mamoru HOSOKAWA, Kariya-city (JP); Takashi UEFUJI, Kariya-city (JP); Hidenori AKITA, Kariya-city (JP)

(21) Appl. No.: 17/317,472

(22) Filed: May 11, 2021

Related U.S. Application Data
(63) Continuation of application No. PCT/JP2019/038300, filed on Sep. 27, 2019.

(30) Foreign Application Priority Data
Nov. 14, 2018 (JP) 2018-214215

(51) Int. Cl. B60W 30/08; B60W 50/14; B62D 15/02

(52) U.S. Cl. CPC B60W 30/08; B60W 2554/4045; B62D 15/021; B60W 50/14

(57) ABSTRACT

An information processing device communicates with a driving assistance device mounted on a driving assistance target vehicle. The information processing device: receives, from a probe vehicle, vehicle information acquired by the probe vehicle; determines a presence or absence of an occurrence of an event based on the vehicle information; calculates a reliability degree indicating a reliability level of a determination result; and transmits, to the driving assistance device, the determination result and the reliability degree.

### CROSS REFERENCE TO RELATED APPLICATIONS

The present application is a continuation application of International Patent Application No. PCT/JP 2019/038300 filed on Sep. 27, 2019, which designated the U.S. and claims the benefit of priority from Japanese Patent Application No. 2018-214215 filed on Nov. 14, 2018. The entire disclosures of all of the above applications are incorporated herein by reference.

### TECHNICAL FIELD

The present disclosure relates to an information processing device and a driving assistance device.

### BACKGROUND

Conventionally, a driving assistance system that alerts a driver of information about collision possibility is known.

### SUMMARY

The present disclosure provides an information processing device, which communicates with a driving assistance device mounted on a driving assistance target vehicle. The information processing device: receives, from a probe vehicle, vehicle information acquired by the probe vehicle; determines a presence or absence of an occurrence of an event based on the vehicle information; calculates a reliability degree indicating a reliability level of a determination result; and transmits, to the driving assistance device, the determination result and the reliability degree.

### BRIEF DESCRIPTION OF DRAWINGS

Objects, features and advantages of the present disclosure will become apparent from the following detailed description made with reference to the accompanying drawings. In the drawings:

FIG. 1 is a diagram showing a configuration of an information processing system according to a first embodiment;

FIG. 2 is a diagram showing a configuration of an information processing device according to the first embodiment;

FIG. 3 is a diagram showing a configuration of a driving assistance device according to the first embodiment;

FIG. 4 is a diagram showing a configuration of a probe vehicle according to the first embodiment;

FIG. 5A and FIG. 5B are diagrams showing travelling patterns of the probe vehicle according to the first embodiment;

FIG. 6A and FIG. 6B are diagrams showing vehicle information of multiple probe vehicles according to the first embodiment;

FIG. 7 is a diagram showing vehicle information of multiple probe vehicles according to the first embodiment;

FIG. 8A and FIG. 8B are diagrams showing travelling patterns of the probe vehicle according to the first embodiment;

FIG. 9A, FIG. 9B, and FIG. 9C are diagrams showing vehicle information of multiple probe vehicles according to the first embodiment;

FIG. 10 is a flowchart showing a process executed by the information processing device according to the first embodiment;

FIG. 11 is a flowchart showing a process executed by the driving assistance device according to the first embodiment;

FIG. 12 is a diagram showing a configuration of a driving assistance device according to a modification example of the first embodiment;

FIG. 13 is a flowchart showing a process executed by the driving assistance device according to the modification example of the first embodiment;

FIG. 14 is a flowchart showing a process executed by an information processing device according to a second embodiment;

FIG. 15 is a flowchart showing a process executed by a driving assistance device according to the second embodiment; and

FIG. 16A and FIG. 16B are diagrams showing configurations of a probe vehicle according to a third embodiment.

### DETAILED DESCRIPTION

An obstacle existing on a road may collide with a vehicle which travels on the road and approaches the obstacle. This kind of obstacle needs to be detected at an early time to avoid a collision accident of the vehicle with the obstacle. Recently, vehicles are equipped with a driving assistance system that alerts a driver of information about collision possibility so that the driver can pay attention to the information. The driving assistance system specifies the obstacle by acquiring, from a preceding vehicle that travels in front of a subject vehicle, a position, a travelling trajectory or the like.

In a known art, trajectory information is collected from multiple vehicles traveling on a road, a difference between a normal traveling and a traveling around an occurrence location of an obstacle is detected, and the occurrence location of the obstacle is specified. In this configuration, whether an obstacle actually exists is determined based on multiple records of the trajectory information of vehicles collected by an obstacle detection center device.

According to the above-described technology, when avoidance travelling is determined at a same position within a predetermined period based on trajectory information acquired from multiple probe vehicles, it is determined that an obstacle may exist at the position with a high possibility. In a case where an obstacle, such as a parked vehicle, a temporarily stopped vehicle, a broken down vehicle (hereinafter referred to as a stopped vehicle), or a vehicle running in wrong way is detected, the information related to the detected obstacle needs to be provided to the following vehicles in order to avoid the detected obstacle or to instruct the following vehicles to execute a process in order to avoid the detected obstacle. Based on a study made by the inventors of the present disclosure, when the detection of the stopped vehicles is erroneously made caused by a detection of a simple lane change or the detection of the stopped vehicles is made prior to a predetermined time period, the providing of the information about the stopped vehicles or execution of the avoidance travelling may be not proper to the following vehicles.

According to an aspect of the present disclosure, an information processing device, which communicates with a driving assistance device mounted on a driving assistance target vehicle, includes: a reception unit configured to receive, from a probe vehicle, vehicle information acquired by the probe vehicle; a determination unit configured to determine a presence or absence of an occurrence of an event based on the vehicle information; a calculation unit configured to calculate a reliability degree indicating a reliability level of a determination result determined by the determination unit; and a transmission unit configured to transmit, to the driving assistance device, the determination result and the reliability degree.

According to another aspect of the present disclosure, a driving assistance device, which is mounted on a driving assistance target vehicle and communicates with an information processing device is provided. The information processing device includes: a reception unit configured to receive, from a probe vehicle, vehicle information acquired by the probe vehicle; a determination unit configured to determine a presence or absence of an occurrence of an event based on the vehicle information; a calculation unit configured to calculate a reliability degree indicating a reliability level of a determination result determined by the determination unit; and a transmission unit configured to transmit the determination result and the reliability degree to the driving assistance device. The driving assistance device includes: a reception unit configured to receive the determination result and the reliability degree transmitted from the information processing device; a calculation unit configured to determine whether the reliability degree is equal to or higher than a predetermined first threshold; and a notification unit configured to notify the occurrence of the event to a driver of the driving assistance target vehicle in a case where the reliability degree is determined to be equal to or higher than the first threshold.

According to another aspect of the present disclosure, a program product stored in a computer readable non-transitory tangible medium and executed by an information processing device is provided. The information processing device communicates with a driving assistance device mounted on a driving assistance target vehicle. The program product executed by the information processing device includes instructions for: receiving, from a probe vehicle, vehicle information acquired by the probe vehicle; determining an event occurrence based on the vehicle information; calculating a reliability degree indicating a reliability level of a determination result of the event occurrence; and transmitting the determination result and the reliability degree to the driving assistance device.

According to another aspect of the present disclosure, a program product stored in a computer readable non-transitory tangible medium and executed by a driving assistance device is provided. The driving assistance device is mounted on a driving assistance target vehicle and communicates with an information processing device. The information processing device includes: a reception unit configured to receive, from a probe vehicle, vehicle information acquired by the probe vehicle; a determination unit configured to determine a presence or absence of an occurrence of an event based on the vehicle information; a calculation unit configured to calculate a reliability degree indicating a reliability level of a determination result determined by the determination unit; and a transmission unit configured to transmit the determination result and the reliability degree to the driving assistance device. The program product executed by the driving assistance device includes instructions for: receiving the determination result and the reliability degree transmitted from the information processing device; determining whether the reliability degree is equal to or higher than a predetermined first threshold; and notifying the occurrence of the event to a driver of the driving assistance target vehicle in a case where the reliability degree is equal to or higher than the first threshold.

With the information processing device, the driving assistance device, and program products described above, a reliability of a determination result indicating a result whether an event is occurred or not is calculated. Thus, information indicating an occurrence of an event can be properly provided to the driving assistance device.

The following will describe embodiments of the present disclosure with reference to the accompanying drawings.

In the present disclosure, the configuration disclosed in each embodiment is not limited to each embodiment alone, but may be combined across the embodiments.

For example, the configuration disclosed in one embodiment may be combined with another embodiment. Further, the disclosed configurations may be collected and combined in each of multiple embodiments.

The difficulty described in the present disclosure is not publicly known, but persons including the inventor have independently found out, and is a fact that affirms the inventive step together with the configuration and method of the present disclosure.

### First Embodiment

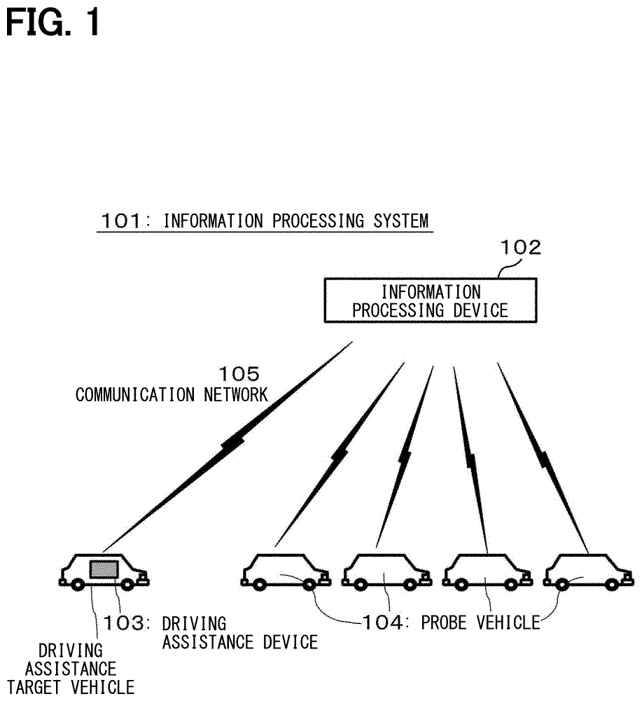

The following will describe configurations of an information processing system, an information processing device, a driving assistance device, a probe vehicle according to the present embodiment with reference to FIG. 1 to FIG. 4.

1. Configuration of Information Processing System

FIG. 1 shows an information processing system for vehicle use, and the information processing system includes an information processing device, a driving assistance device mounted on a following vehicle, and multiple probe vehicles. The following vehicle corresponds to a driving assistance target vehicle. In the information processing system 101 shown in FIG. 1, the information processing device 102, the multiple probe vehicles 104, and the driving assistance device 103 mounted on the driving assistance target vehicle, which is the following vehicle, are connected via a communication network 105.

The information processing device 102 communicates data with the driving assistance device 103 using the communication network 105. The information processing device 102 communicates data, such as vehicle information with the multiple probe vehicles 104 using the communication network 105. With consideration of a distance to the information processing device 102, when a communication distance is short, the communication network 105 may adopt a communication method of a wireless LAN, such as IEEE802.11 (WiFi) or IEEE802.15. When the communication distance is long, the communication network 105 may adopt a communication method of wide area network, such as CDMA2000 (registered trademark), W-CDMA (Wideband Code Division Multiple Access), HSPA (High Speed Packet Access), LTE (Long Term Evolution), LTE-A (Long Term Evolution Advanced).

Regarding the communication between the information processing device 102 and the driving assistance device 103, communication method based on in-vehicle network, such as CAN (Controller Area Network), LIN (Local Interconnect Network) may be used or communication method of Ethernet (registered trademark) or Bluetooth (registered trademark) may be used in a case where the information processing device 102 and the driving assistance device 103 are mounted on the same driving assistance target vehicle.

FIG. 1 shows an example in which the information processing system 101 includes the information processing device 102, the driving assistance device 103, and multiple probe vehicles 104. Alternatively, the information processing system 101 may include one or more information processing devices that are connected with one another through the communication network 105.

2. Configuration of Information Processing Device

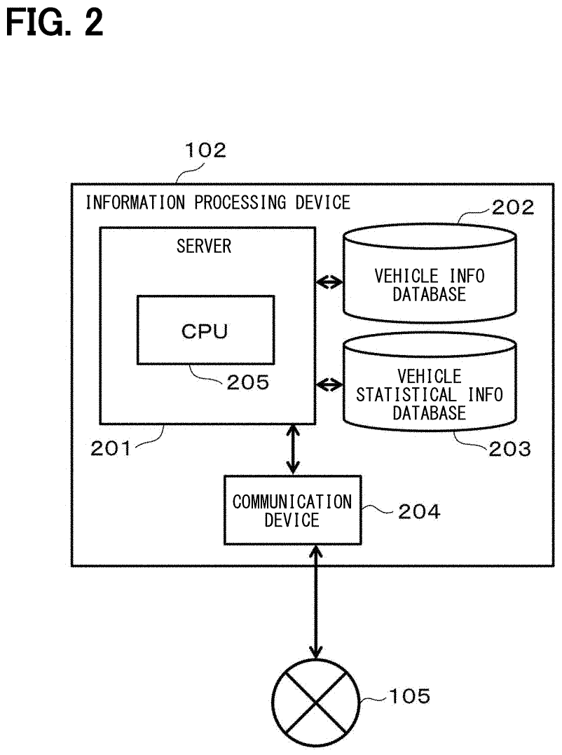

FIG. 2 shows a configuration of the “information processing device” that functions as a probe center. The information processing device 102 shown in FIG. 2 is provided mainly by a semiconductor device, and includes a server 201, a vehicle information database 202, a vehicle statistical information database 203, and a communication device 204. The server 201 includes a CPU (Central Processing Unit) 205, a ROM (Read Only Memory), a RAM (Random Access Memory), which are not shown. The CPU 205 functions as a “determination unit” and a “calculation unit” in the present disclosure. Each of the vehicle information database 202 and the vehicle statistical information database 203 is provided by a non-volatile storage unit (not shown), such as an HDD or a flash memory. Further, the communication device 204 functions as a “reception unit” and a “transmission unit” in the present disclosure, and includes a network interface (not shown) connected to the communication network 105.

The information processing device 102 may be provided by a packaged semiconductor device or a configuration in which respective semiconductor devices are connected by wiring on a wiring board.

The “information processing device” of the present disclosure includes a case where it is installed outside the driving assistance target vehicle, and also includes a case where it is installed to the driving assistance target vehicle. An installation position of the information processing device may be set properly.

FIG. 2 shows an example in which the information processing device 102 is a dedicated information processing device that executes functions of the present disclosure. However, the information processing device does not necessarily have to be the dedicated information processing device, and may be provided by an information processing device having other functions. In this case, the information processing device having other functions may be configured to also have the function described in the present disclosure.

3. Configuration of Driving Assistance Device

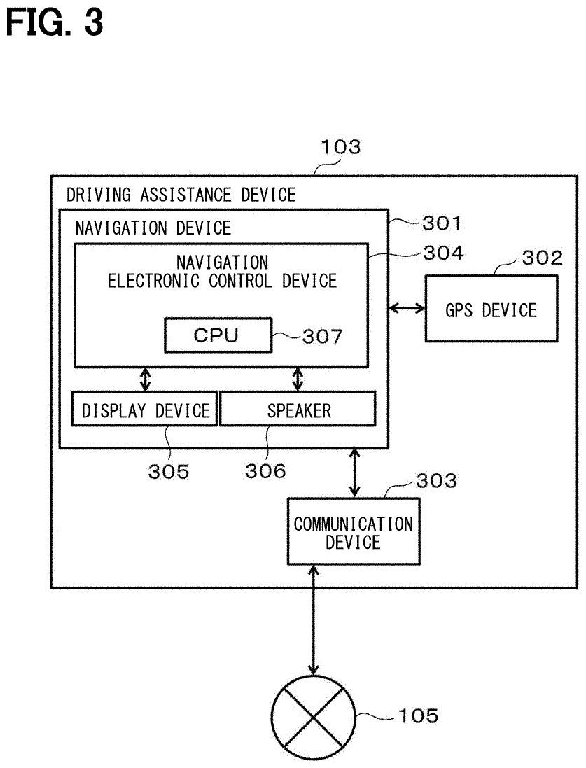

FIG. 3 shows a configuration of the “driving assistance device” mounted on the driving assistance target vehicle, which is a following vehicle of the probe vehicle 104. The driving assistance device 103 shown in FIG. 3 includes a navigation device 301, a GPS (Global Positioning System) 302, and a communication device 303. The navigation device 301 includes a navigation electronic control device 304, a display device 305, and a speaker 306. The display device 305 and the speaker 306 function as a “notification unit” in the present disclosure. The navigation electronic control device 304 includes a CPU 307, a ROM, and a RAM, which are not shown The GPS device 302 may be provided by a GPS, a differential GPS, or an inertial navigation system (INS). The communication device 303 includes a network interface (not shown) connected to the communication network 105.

Examples of driving assistance device according to the present disclosure include a semiconductor device, an electronic circuit, a module, and a microcomputer. In addition, necessary functions such as an antenna and a communication interface may be properly added to these devices. Moreover, the driving assistance device may be also possible to provide features such as a vehicle navigation system, a smartphone, a personal computer, and a portable information terminal.

The “driving assistance device” in the present disclosure includes a device that notifies a driver of information by image or audio signal, such as a navigation device. The “driving assistance device” also includes a device that automatically controls the vehicle. The driving assistance may be made directly or indirectly.

4. Configuration of Probe Vehicle

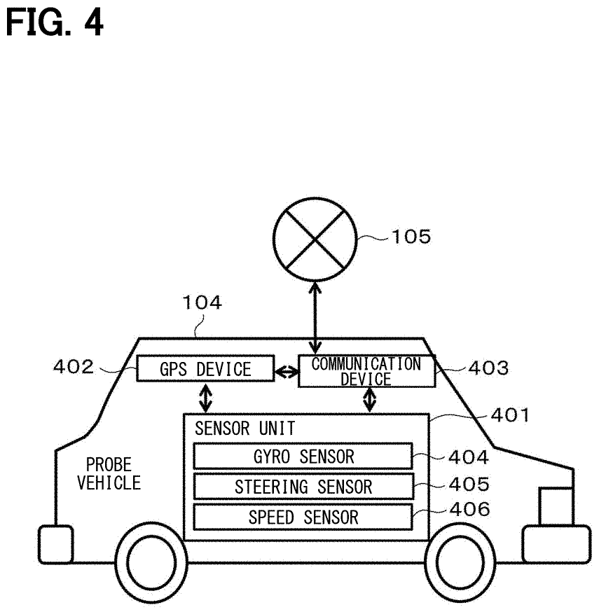

FIG. 4 shows a configuration of a probe vehicle that acquires vehicle information. The probe vehicle 104 shown in FIG. 4 includes a sensor unit 401, a GPS device 402, and a communication device 403. The sensor unit 401 includes a gyro sensor 404, a steering sensor 405, and a speed sensor 406. The GPS device 402 and the communication device 403 may have similar configurations to the GPS device 302 and the communication device 303, respectively.

5. Processes and Operations of the Information Processing Device and Driving Assistance Device

(1) Process Executed by the Information Processing Device

First, a process executed by the information processing device will be described.

(a) The communication device 204 (corresponding to the reception unit) of the information processing device 102 receives the vehicle information from the probe vehicle which “acquires the vehicle information”. Specifically, during a travelling on the road, the probe vehicle 104 transmits, to the information processing device 102, the vehicle information obtained from the sensor unit 401 mounted to the probe vehicle by the communication device 403 at predetermined time intervals. The information processing device 102 receives, by the communication device 204, the vehicle information, which is transmitted from the probe vehicles 104 at predetermined time intervals. Then, the information processing device 102 collects the received vehicle information in the vehicle information database 202. That is, the vehicle information database 202 stores, as big data, the vehicle information of the probe vehicles 104 at predetermined time intervals.

(b) Next, the CPU 205 (corresponding to the “determination unit”) of the information processing device 102 determines “presence/absence of an event occurrence based on” the vehicle information. Specifically, the CPU 205 of the server 201 of the information processing device 102 determines an occurrence of an event, for example, an event obtained based on a correlation between two or more records of vehicle information collected in the vehicle information database 202. Then, the CPU 205 stores the specific vehicle information based on which the event occurrence determination is made in the vehicle statistical information database 203 together with a determination result.

(c) Then, the CPU 205 (corresponding to the “calculation unit”) of the information processing device 102 calculates a “reliability degree” indicating a reliability level of the “determination result”. Specifically, the CPU 205 of the server 201 of the information processing device 102 calculates the reliability degree of the determination result based on the specific vehicle information stored in the vehicle statistical information database 203.

(d) Finally, the communication device 204 (corresponding to the “transmission unit”) of the information processing device 102 transmits the determination result and the reliability degree to the driving assistance device 103.

Hereinafter, each process of receiving of the vehicle information, determining of the event occurrence, and calculation of the reliability degree will be described in order. These processes will be described as the operations executed by the information processing device 102 and the driving assistance device 103.

The “vehicle information” of the present disclosure refers to information related to the probe vehicle, such as a state or a behavior of the probe vehicle and an environment in which the probe vehicle is placed.

The “acquiring” of the present disclosure includes not only a case where the information is collected by the sensor or the like, but also a case where the information is received from another vehicle or a roadside device and a case where the information is generated by the probe vehicle itself.

The term “based on” in the present disclosure indicates a case where the vehicle information is used.

The “event” in the present disclosure refers to a fact that has an influence on vehicle travelling, such as an existence of an “obstacle”. The event may include an existence of a parked vehicle, an existence of a temporarily stopped vehicle, an existence of wrong way driving vehicle, or an existence of traffic jam.

The “obstacle” in the present disclosure may include a tangible object, such as a parked vehicle, a temporarily stopped vehicle, a vehicle in accident, a broken down vehicle, a cargo dropped from a preceding vehicles, a broken tree trunk and tree branches, collapsed earth and sand, an area blocked for handling a traffic accident, a construction area, a blocked area where a travelling is forbidden regardless of a presence or absence of a tangible object.

The “presence/absence” of the present disclosure includes information about a degree or situation in the presence of event occurrence in addition to presence/absence of event occurrence.

The “determination result” of the present disclosure refers to the presence or absence of an event occurrence or information derived from the event.

The “reliability degree” of the present disclosure includes a degree of reliability, and may be represented by a continuous numerical values, discrete degrees, or symbols.

(2) Reception of Vehicle Information

The following will describe an example of received vehicle information, which is transmitted from the probe vehicle.

The probe vehicle 104 acquires various vehicle information at a “specific time” using various sensors of the sensor unit 401 mounted on the probe vehicle 104.

The gyro sensor 404 detects an angle, an attitude, an angular velocity or an angular acceleration of the probe vehicle 104. For example, the gyro sensor 404 detects, as the angular velocity, an inclination of the probe vehicle 104 to the left or right when the probe vehicle 104 changes a travelling course. The angular velocity is one of the vehicle information.

The steering sensor 405 detects an azimuth angle of a steering wheel of the probe vehicle 104. For example, the steering sensor 405 detects, as a steering angle which is one of the vehicle information, a steering amount and a steering direction of the steering wheel of the probe vehicle when the probe vehicle changes the travelling course.

The speed sensor 406 detects a speed of the probe vehicle 104. For example, when the probe vehicle 104 decelerates immediately before changing the travelling course, the speed sensor 406 detects, as speed information which is one of the vehicle information, the speeds of the probe vehicle 104 before and after the deceleration.

The GPS device 402 acquires position information at the specific time. The GPS device 402 receives a signal from the GPS satellite and detects a current position of the probe vehicle 104. For example, when the probe vehicle 104 changes the travelling course, the GPS device 402 detects, as position information which is one of the vehicle information, longitude and latitude information before and after the change of travelling course of the probe vehicle 104.

The “specific time” of the present disclosure may be a period of time.

(3) Determination of the Presence or Absence of Event Occurrence

In the present embodiment, it is noted that an existence of the stopped vehicle is described as an example of the event. The presence or absence of the stopped vehicle is determined by first (a) determining of presence or absence of a lane change of the probe vehicle, and then (b) determining of presence or absence of the stopped vehicle.

(a) Determination of Presence or Absence of Lane Change of Probe Vehicle

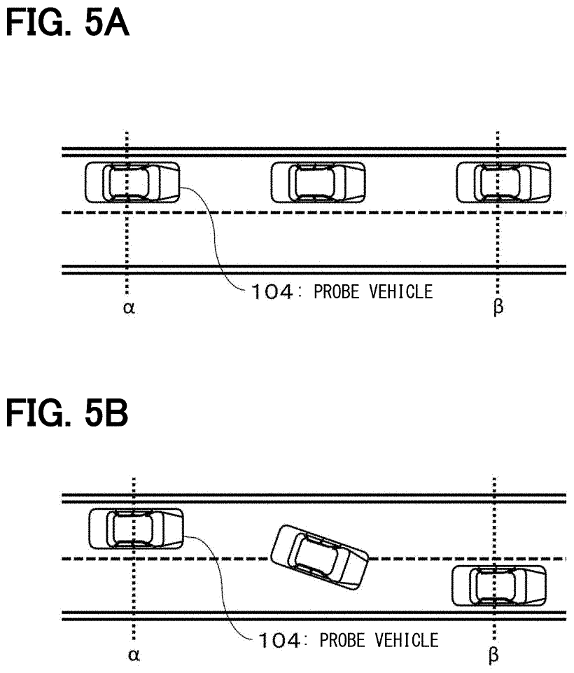

The following will describe, with reference to FIG. 5A and FIG. 5B, traveling patterns of the probe vehicle 104 when the probe vehicle 104 travels in a certain direction and characteristics of vehicle information obtained in each traveling pattern.

FIG. 5A and FIG. 5B show traveling patterns of the probe vehicle 104 when the probe vehicle 104 travels in a certain direction. There may be two travelling patterns of the probe vehicle 104 in a case where the probe vehicle 104 travels in a first lane at a point α on a road having the first lane and a second lane and then passes through a point β where a stopped vehicle may exist. A first traveling pattern is a straight traveling in the first lane at the point β, and a second traveling pattern is a lane change and traveling in the second lane at the point β.

FIG. 5A is a diagram showing the first traveling pattern in which the probe vehicle 104 travels straight in the first lane without changing the lane when passing the point β. When the probe vehicle 104 travels in the first traveling pattern, the vehicle information including various information obtained by the gyro sensor 404, the steering sensor 405, and the speed sensor 406 of the sensor unit 401 may have no significant change among a specific time of traveling before the point α, a specific time of traveling between the point α and the point β, and a specific time of traveling after the point β. Further, the position information obtained by the GPS device 402 is the latitude and longitude indicating straight travelling at three positions which include before the point α, between the point α and the point β, and after the point β.

FIG. 5B is a diagram showing the second traveling pattern in which the probe vehicle 104 moves to the second lane before passing the point β and travels in the second lane when passing the point β. When the probe vehicle 104 travels in the second traveling pattern, information about the angular velocity, the azimuth angle of the steering wheel, and the speed obtained by the gyro sensor 404, the steering sensor 405, and the speed sensor 406 of the sensor unit 401 may be changed by an amount equal to or greater than a certain level among the specific time of traveling before the point α, the specific time of traveling between the point α and the point β, and the specific time of traveling after the point β. Further, the position information obtained by the GPS device 402 is the latitude and longitude indicating lane change at three positions which include before the point α, between the point α and the point β, and after the point β.

The following will describe determination of presence or absence of lane change based on the vehicle information obtained by the information processing device. The CPU 205 of the information processing device 102 extracts vehicle information corresponding to the second traveling pattern from the vehicle information database 202 based on the temporal changes of the angular velocity, the azimuth direction of steering wheel, speed information, and position information of the probe vehicle 104 stored in the database. Then, based on the vehicle information, a lane change flag is set in response to a determination of lane change, and the lane change flag is stored in the vehicle statistical information database 203.

The following will describe a method of determination of presence or absence of lance change with use of specific vehicle information.

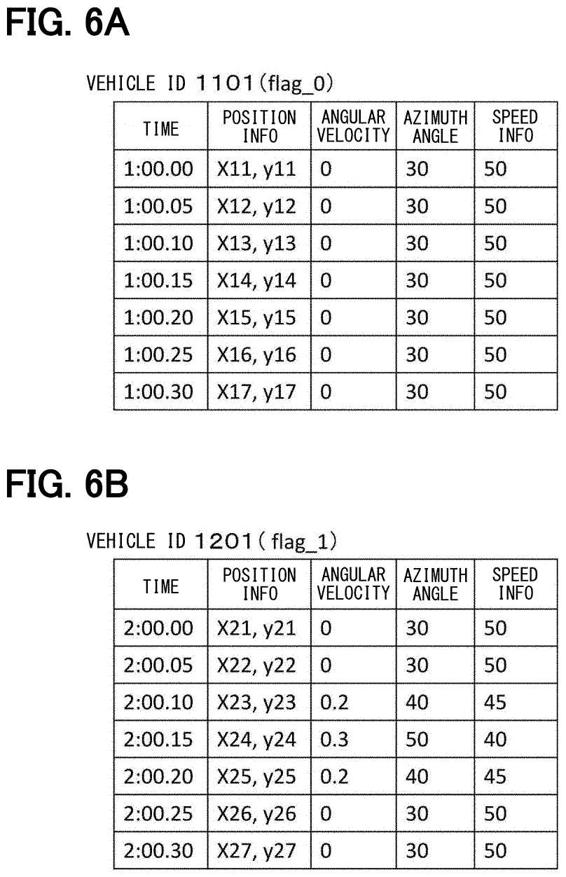

FIG. 6A and FIG. 6B show examples of vehicle information obtained from two probe vehicles at predetermined time intervals. In FIG. 6A and FIG. 6B, the position information is the latitude and longitude of the probe vehicle 104 obtained by the GPS device 402 at the specific time, the angular velocity is the inclination of the probe vehicle 104 obtained by the gyro sensor 404 at the specific time, the azimuth angle is the azimuth angle of the steering wheel of the probe vehicle 104 obtained by the steering sensor 405 at the specific time, and the speed information indicates the speed of the probe vehicle 104 obtained by the speed sensor 406 at the specific time.

The vehicle information shown in FIG. 6A and FIG. 6B is only an example, and the probe vehicle 104 may transmit different information from the information shown in FIG. 6A and FIG. 6B to the information processing device 102.

FIG. 6A shows vehicle information acquired by the vehicle having ID 1101. In FIG. 6A, the vehicle having ID 1101 does not have a significant change in the angular velocity, the azimuth angle, and the speed information between the time points of 1:00.00 and 1:00.30. The vehicle having ID 1101 has latitude and longitude which indicate a straight travelling between the time points of 1:00.00 and 1:00.30. Therefore, it is determined that the vehicle having ID 1101 did not change the lane between the time points of 1:00.00 and 1:00.30, and the lane change flag is not set in each vehicle information of the vehicle having ID 1101 (for example, the lane change flag is set to 0).

FIG. 6B shows vehicle information acquired by the vehicle having ID 1201. In FIG. 6B, the vehicle having ID 1201 has a certain amount change equal to or greater than a predetermined level in the angular velocity, the azimuth angle, and the speed information between the time points of 2:00.00 and 2:00.30. The vehicle having ID 1201 has latitude and longitude which indicate a lane change between the time points of 2:00.00 and 2:00.30. Therefore, it is determined that the vehicle having ID 1201 has changed the lane between the time points of 2:00.00 and 2:00.30, and the lane change flag is set in each vehicle information of the vehicle having ID 1201 (for example, the lane change flag is set to 1)

An example using, as the vehicle information, the angular velocity, the azimuth angle, and the speed for determining presence or absence of lane change is described. However, the lane change may be made while maintaining a constant speed, and the speed may eliminated from the vehicle information based on which the presence or absence of lane change is determined.

The vehicle ID is identification number of the vehicle information. Alternative, an absolute identification code or a relative identification code may be used as the vehicle ID under a condition that the vehicle can be identified from one another.

(b) Determination of Presence or Absence of Stopped Vehicle

The following will describe a determination method of presence or absence of stopped vehicle based on the determination result of presence or absence of lance change made by the probe vehicle.

In the first traveling pattern, since the probe vehicle 104 has not changed the lane, it is clear that a stopped vehicle does not exist in the first lane at the point β. In the second traveling pattern, the probe vehicle 104 has changed the lane. However, it is not clear that whether a stopped vehicle exists in the first lane at the point β. The vehicle changes the lane not only when there is a stopped vehicle in the currently travelling lane, but also for the purpose of overtaking another vehicle, making a right turn later, making a left turn later, or smoothly making a route change later. Therefore, it cannot be assumed that there is a stopped vehicle on the first lane at the point β in response to a single probe vehicle 104 changing the lane.

However, when a certain number of probe vehicles 104 change lanes within a certain section in a specific time, it is considered that the probe vehicles 104 have changed the lanes because there is a stopped vehicle in the first lane at the point β. Thus, in this case, an existence of the stopped vehicle may be determined.

In the present embodiment, the presence or absence of a stopped vehicle is determined based on the vehicle information which satisfies a condition including a predetermined threshold value (corresponding to a “second threshold”). Specifically, when determining vehicle information indicating a certain number of vehicles made lane changes in a certain section in a specific time, that is, there is a certain number of vehicle information with the lane change flag being set, the presence of the stopped vehicle is determined and a stopped vehicle flag is set. Then, the determination result indicating the presence of the stopped vehicle is provided to the following vehicles.

The threshold values corresponding to the specific time, the section, and the number of vehicles used for determining the presence or absence of the stopped vehicle may be set based on an event duration, position information and the number of probe vehicles, which are set in advance for each event. For example, for a presence of the stopped vehicle, which is described as the event of the present embodiment, the threshold values of the condition may be set as whether five probe vehicles change lanes within 5 minutes in an area where a start position of the lane change is within 8.35 meters in the traveling direction.

The time threshold is set to 5 minutes because a Road Traffic Act which defines that a stop for loading or unloading of luggage cannot exceed 5 minutes.

The threshold of section is set as the start position of the lane change is within 8.35 meters in the traveling direction. Suppose that a transmission interval of the vehicle information from the probe vehicle is set as 0.5 second and the probe vehicle runs at a speed of 60 kilometers per hour. In this case, the probe vehicle travels 16.7 meters in one second, and travels 8.35 meters in 0.5 second. In a case where the vehicle information show that multiple probe vehicles have changed the lanes within 8.35 meters, it can be estimated that the multiple probe vehicles changed the lanes for the same purpose of avoiding the stopped vehicle when passing by the stopped vehicle.

The threshold number of probe vehicles is set to 5. This threshold number is calculated based on a probability of 0.198 which indicates a connected vehicle among vehicles travelling on a road, a travelling frequency of 6 vehicles per minute usually travelling on the road, and a permitted vehicle's stop time of 5 minutes on the road. The probability of 0.198 which indicates the connected vehicle among vehicles travelling on the road is calculated based on a total estimated number of connected vehicles which may be implemented by the year of 2020. The connected vehicles mean vehicles that are constantly connected to the internet and communicate with the internet.

The threshold values of the time, the section, and the number of vehicles may be properly corrected in response to, for example, a change in the transmission interval of vehicle information, a change in the estimated number of connected vehicles, or the like.

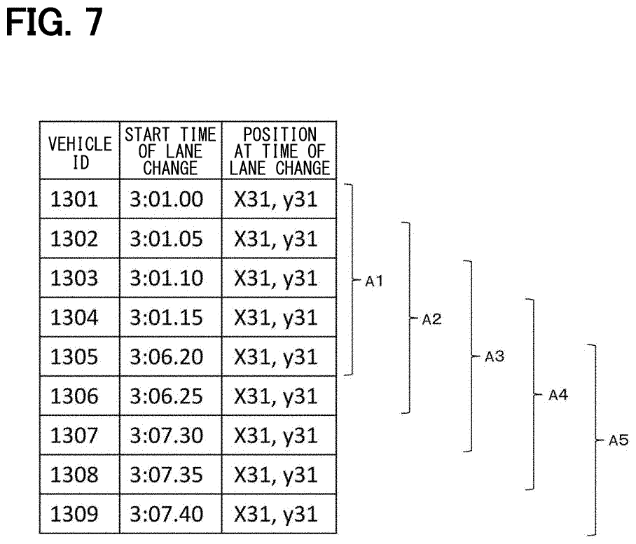

The following will describe a method of determination of presence or absence of stopped vehicle with use of specific vehicle information. FIG. 7 shows an example of a series of vehicle information to which the lane change flag is set and stored in the vehicle statistical information database 203.

FIG. 7 shows a lane change start time of each probe vehicle 104 having vehicle IDs of 1301 to 1309 and the position of the probe vehicles 104 at the time of lane change start. Further, in FIG. 7, based on a threshold value 5 of vehicle numbers, a group of vehicles having IDs of 1301 to 1305, a group of vehicles having IDs of 1302 to 1306, a group of vehicles having IDs of 1303 to 1307, a group of vehicles having IDs of 1304 to 1308, and a group of vehicles having IDs of 1305 to 1309 are divided as a group A1, a group A2, a group A3, a group A4, and a group A5, respectively.

In the group A1, the vehicles having IDs of 1301 to 1304 are within the time threshold value of 5 minutes, but the vehicle having ID of 1305 exceeds the time threshold value of 5 minutes. Thus, it is determined that there is no stopped vehicle for the group A1. In the group A2, the vehicles having IDs of 1302 to 1304 are within the time threshold value of 5 minutes, but the vehicles having IDs of 1305 and 1306 exceed the time threshold value of 5 minutes. Thus, it is determined that there is no stopped vehicle for the group A2. In the group A3, the vehicles having IDs of 1303 and 1304 are within the time threshold value of 5 minutes, but the vehicles having IDs of 1305 to 1307 exceed the time threshold value of 5 minutes. Thus, it is determined that there is no stopped vehicle for the group A3. In the group A4, except the vehicle having ID of 1304, the vehicles having IDs of 1305 to 1308 exceed the time threshold value of 5 minutes. Thus, it is determined that there is no stopped vehicle for the group A4. In the group A5, since all of the vehicles having IDs of 1305 to 1309 are within the time threshold value of 5 minutes. Thus, presence of the stopped vehicle is determined.

In the example shown in FIG. 7, the threshold value of the number of vehicles is set to 5. The positions of the vehicles having IDs of 1301 to 1309 during the lane change are all represented by X31 and Y31 for description convenience. In the example, the presence of stopped vehicle is determined only based on the time threshold value, which is a difference of the time points. Needless to say, when the position during the lane change is different from one another, the difference of position also needs to be taken into consideration when determining the presence or absence of stopped vehicle.

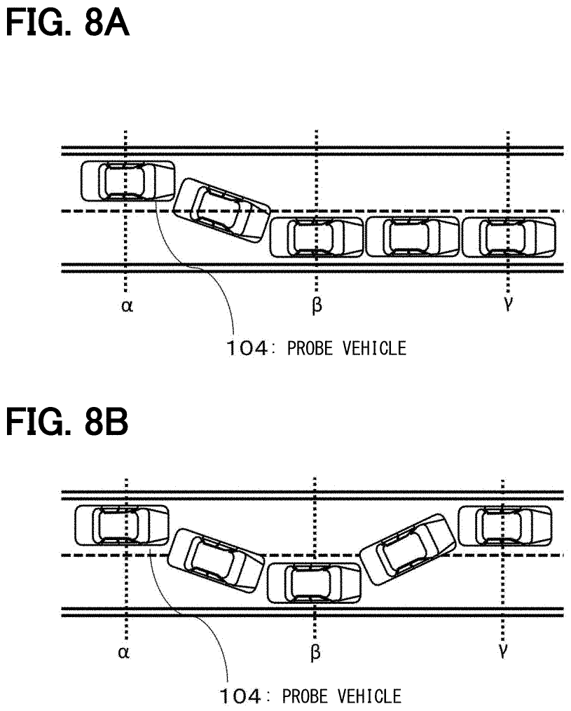

As described above, when the presence of the stopped vehicle is considered as the event occurrence, the determination of event occurrence is made in two steps: (a) determination of presence or absence of lane change, and (b) determination of presence or absence of stopped vehicle. However, the present disclosure is not limited to this example. For another example, instead of (a) determination of presence or absence of lane change, a determination of travelling pattern may be carried out as shown in FIG. 8A and FIG. 8B, and in (b), the determination of presence or absence of stopped vehicle may be executed based on the threshold value set corresponding to the travelling pattern.

(4) Calculation of Reliability Degree

The following will describe an overview of reliability degree, a determination of probability, a calculation of newness degree, a calculation example of reliability degree, and a threshold value of the reliability degree in the described order.

(a) Overview of Reliability Degree

The driving assistance target vehicle, which is the following vehicle, needs to obtain highly accurate and real time information on the presence or absence of a stopped vehicle. In addition to the determination result indicating the presence or absence of the stopped vehicle determined based on the lane change of the probe vehicle as the preceding vehicle, by evaluating an accuracy and an acquiring time of the determination result indicating the presence or absence of the stopped vehicle, a reliability of the determination result indicating the presence or absence of the stopped vehicle can be increased.

In the present embodiment, in order to increase the reliability of the determination result indicating the presence or absence of the stopped vehicle, a reliability degree indicating the reliability of the he determination result indicating the presence or absence of the stopped vehicle is calculated.

The reliability degree is calculated based on the vehicle information of the probe vehicle 104 which is used to determine the presence of the stopped vehicle. Specifically, the reliability degree is obtained by calculating an average value of a product of the probability degree of each vehicle information of the probe vehicle 104 and the newness degree of the vehicle information of the probe vehicle 104. The probability degree of each vehicle information is calculated based on each piece of multiple vehicle information corresponding to the probe vehicles to which the stopped vehicle flags are set. The newness degree of each vehicle information is calculated based on each piece of multiple vehicle information corresponding to the probe vehicles to which the stopped vehicle flags are set. The reliability degree is calculated by the following mathematical expression 1 or mathematical expression 2 based on the probability degree and the newness degree of the vehicle information.

$$\begin{matrix}C = \frac{{\sum }_{i = 1}^{n} {R}_{i} \cdot {F}_{i}}{n} \times 100 [ \% ] & ( Mathematical expression 1 ) \\ C = {\sum }_{i = 1}^{n} {R}_{i} \cdot {F}_{i} & ( Mathematical expression 2 )\end{matrix}$$

Herein, C represents the reliability degree, Ri represents the probability degree, Fi represents the newness degree, i represents the identification number of the vehicle information, and n represents the number of probe vehicles.

The “probability degree” of the present disclosure refers to an index indicating a possibility of an event or information, or a possibility of an event occurrence or information occurrence.

The “newness degree” of the present disclosure indicates a level of newness of an event or information.

(b) Determination of Probability Degree

The following will describe the probability degree used in the calculation of the reliability degree. The probability degree is specified and determined based on an evaluation value determined according to the “travelling pattern” of the probe vehicle.

Suppose that the lane change from the first lane to the second lane, to which the lane change flag is set, is defined as a first lane change, and the lane change from the second lane to the first lane for returning to the first lane after the first lane change is defined as a second lane change. The evaluation value of an occurrence of the second lane change is set to 0.7, and the evaluation value of non-occurrence of the second lane change is set to 0.3. The evaluation value of non-occurrence of the second lane change is set to be smaller than the evaluation value of the occurrence of the second lane change. This is because, the second lane change is less likely to be performed even in a case where there is no stopped vehicle.

The evaluation value is not limited to the above-described example, and can be changed as appropriate.

The “second lane” of the present disclosure may be a single or multiple lanes having the same travelling direction as the first lane, or may be a single or multiple lanes in the opposite directions to the first lane. The first lane may be considered as a lane on a road having only one lane on each travelling direction. In this case, the second lane may correspond to a road shoulder.

Further, the “traveling pattern” of the probe vehicle of the present disclosure is a traveling pattern specified based on the vehicle information transmitted from one probe vehicle. Alternatively, the traveling may be specified based on the vehicle information transmitted from another probe vehicle in addition to the vehicle information transmitted from the one probe vehicle.

The following will describe the second lane change. In the second travelling pattern described in FIG. 5B, two travelling patterns may be considered when the vehicle passes a subsequent point γ. One of the two travelling patterns corresponds to a case where the second lane change is made, and the other one of the two travelling patterns corresponds to a case where the second lane change is not made. The following will describe traveling patterns of the probe vehicle 104 when the probe vehicle 104 travels in a certain direction and characteristics of vehicle information obtained in each traveling pattern.

FIG. 8A and FIG. 8B show traveling patterns of the probe vehicle 104 when the probe vehicle 104 travels in a certain direction. There may be two travelling patterns of the probe vehicle 104 when the probe vehicle 104 passes the subsequent point γ in a case where the probe vehicle 104 travels in the first lane at the point α on the road having the first lane and the second lane and travels in the second line at the point β where a stopped vehicle may exist. That is, a 2-1 travelling pattern is defined as a travelling pattern in which the vehicle continuously travels in the second lane after one time of lane change, and a 2-2 travelling pattern is defined as a travelling pattern in which the vehicle returns to the first lane by performing additional lane change. In the 2-2 travelling pattern, the vehicle changes the lane twice in total.

FIG. 8A is a diagram showing the 2-1 traveling pattern in which the probe vehicle 104 moves to the second lane by one time of lane change before passing the points β and γ and travels in the second lane when passing the point β. When the probe vehicle 104 travels in the 2-1 travelling pattern, information about the angular velocity, the azimuth angle of the steering wheel, and the speed obtained by the gyro sensor 404, the steering sensor 405, and the speed sensor 406 of the sensor unit 401 may be changed by an amount equal to or greater than a certain level among the specific time of traveling before the point α, the specific time of traveling between the point α and the point β, and the specific time of traveling after the point β. Further, the position information obtained by the GPS device 402 is the latitude and longitude indicating lane change at three positions which include before the point α, between the point α and the point β, and after the point β. The information about the angular velocity, the azimuth angle of the steering wheel, and the speed obtained by the gyro sensor 404, the steering sensor 405, and the speed sensor 406 of the sensor unit 401 have no significant change among the specific time of traveling before the point β, a specific time of traveling between the point β and the point γ, and a specific time of traveling after the point γ. Further, the position information obtained by the GPS device 402 is the latitude and longitude indicating straight travelling at three positions which include before the point β, between the point β and the point γ, and after the point γ.

FIG. 8B is a diagram showing the 2-2 traveling pattern in which the probe vehicle 104 changes the lane by twice before and after passing the point β, travels in the second lane when passing the point β, and travels in the first lane when passing the point γ. When the probe vehicle 104 travels in the 2-2 traveling pattern, information about the angular velocity, the azimuth angle of the steering wheel, and the speed obtained by the gyro sensor 404, the steering sensor 405, and the speed sensor 406 of the sensor unit 401 may be changed by an amount equal to or greater than a certain level among the specific time of traveling before the point α, the specific time of traveling between the point α and the point β, and the specific time of traveling after the point β. Further, the position information obtained by the GPS device 402 is the latitude and longitude indicating lane change at three positions which include before the point α, between the point α and the point β, and after the point β. The information about the angular velocity, the azimuth angle of the steering wheel, and the speed obtained by the gyro sensor 404, the steering sensor 405, and the speed sensor 406 of the sensor unit 401 are changed by an amount equal to or greater than a certain level among the specific time of traveling before the point β, a specific time of traveling between the point β and the point γ, and a specific time of traveling after the point γ. Further, the position information obtained by the GPS device 402 is the latitude and longitude indicating the lane change at three positions which include before the point β, between the point β and the point γ, and after the point γ.

Based on the vehicle information transmitted from the probe vehicle 104, the 2-1 traveling pattern and the 2-2 traveling pattern are detected and determined, and the probability degree is determined for each vehicle information of each probe vehicle 104 with reference to the determination result of the travelling pattern.

In specifying of the probability degree, the evaluation value may be properly changed or may be weighted according to the function of the sensor unit 401 of the probe vehicle 104. This is because, when the sensor unit 401 has a high detection ability, the detection and determination result of the 2-1 traveling pattern or the 2-2 traveling pattern becomes more reliable.

In specifying of the probability degree, the evaluation value of the traveling pattern may be properly changed or the evaluation value may be weighted according to the number of satellites used in the measurement of position information by the GPS device 402 of the probe vehicle 104. When the number of satellites is large, the position information becomes more accurate. Thus, the detection and determination result of the 2-1 traveling pattern or the 2-2 traveling pattern becomes more reliable.

In specifying of the probability degree, the evaluation value may be properly changed or may be weighted according to the travelling area of the probe vehicle 104. For example, in urban areas, roads have a high density, large number of at-grade intersections and grade separations. Thus, it is possible that the determination of road on which the probe vehicle is travelling may fail only based on the latitude and longitude of the probe vehicle. In suburban areas, there is no road congestion, and it is highly possible that the road on which the probe vehicle travels can be clearly identified by the latitude and longitude. In the suburban area, the determine result of the 2-1 driving pattern or the 2-2 driving pattern becomes more reliable.

For another example, in specifying of the probability degree, the evaluation value may be properly changed or may be weighted according to the speed of the probe vehicle 104.

(c) Calculation of Newness Degree

The following will describe a calculation method of the newness degree which is used in the calculation of the reliability degree. The newness degree is calculated by the mathematical expression 3.

$${F}_{i} = 1 - \frac{{t}_{i}}{M} \qquad ( Mathematical expression 3 )$$

Herein, Fi represents the newness degree, i represents the identification number of the vehicle information, ti represents a duration from a start time of the first lane change to the current time, and M represents a duration of the event which is defined for each event. The newness degree calculated by the above mathematical expression has a low value for the first lane change which has a start time long before the current time, and has a high value for the first lane change which has a start time close to the current time.

(d) Example of Calculation of Reliability Degree

The following will describe the presence or absence of the stopped vehicle determined with consideration of an appearance time and disappearance time of the stopped vehicle, and the determination of the presence or absence of the stopped vehicle in each situation.

The situations of the presence or absence of the stopped vehicle during the travelling of the probe vehicle 104 that has changed the lane may include the following 5 situations when the appearance time and the disappearance time of the stopped vehicle at the point β shown in FIG. 5A, FIG. 5B, FIG. 8A, and FIG. 8B. The first situation is the presence of the stopped vehicle in a case where all of a certain number of probe vehicles 104 change the lane. The second situation is the presence of the stopped vehicle in a case where partial of the certain number of probe vehicles 104 at the end change the lane. The third situation is the presence of the stopped vehicle in a case where partial of the certain number of probe vehicles 104 at a position except the beginning and end change the lane. The fourth situation is the presence of the stopped vehicle in a case where partial of the certain number of probe vehicles 104 at the beginning change the lane. The fifth situation is the absence of the stopped vehicle in a case where all of the certain number of the probe vehicles 104 change the line.

Among the first situation to the fifth situation, in the first situation and the second situation, since the stopped vehicle exists when the last several number of probe vehicles 104 change the line, the reliability degree is high. Among the first situation to the fifth situation, in the third situation to the fifth situation, since the stopped vehicle does not exist when the last several number of probe vehicles 104 change the line, the reliability degree is low.

The following will describe a calculation method of the reliability degree with use of the specific vehicle information.

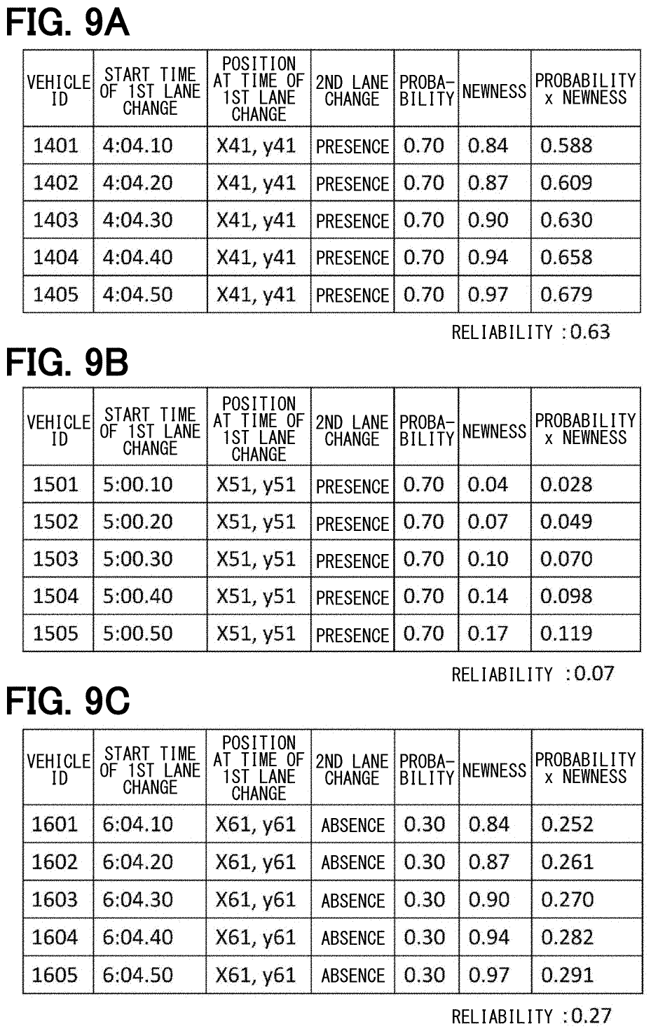

FIG. 9A to FIG. 9C are examples of vehicle information obtained from five probe vehicles when presence of lane change and presence of the stopped vehicle are determined. In calculation of the reliability degree based on the vehicle information shown in FIG. 9A to FIG. 9C, the current times in FIG. 9A to FIG. 9C are set to 4:05, 5:05, and 6:05, respectively.

FIG. 9A shows, for each of the probe vehicles 104 having IDs of 1401 to 1405, a start time of the first lane change, a first lane change position, a presence or absence of the second lane change, a probability degree, a newness degree, and a product of the probability degree and the newness degree. The probe vehicles having IDs of 1401 to 1405 have the start time of the first lane change close to the current time of 4:05, which is within one minute. Thus, the start time of the first lane change of the probe vehicles having IDs of 1401 to 1405 are relatively new. Thus, the newness degree calculated by the mathematical expression has a high value. The vehicles travel in the 2-2 travelling patter which performs the second lane change. Thus, the probability degree for each of the vehicles is set as 0.70. The reliability degree is calculated based on the vehicle information of the probe vehicles having IDs of 1401 to 1405 using the mathematical expression 1. The calculated reliability degree has a value of 0.63.

FIG. 9B shows an example of vehicle information having IDs of 1501 to 1505. The probe vehicles having IDs of 1501 to 1505 have the start time of the first lane change before the current time of 5:05, which is within five minutes. Thus, the start time of the first lane change of the probe vehicles having IDs of 1501 to 1505 are relatively old. Thus, the newness degree calculated by the mathematical expression 2 has a low value. The probability degree is the same as in FIG. 9A. The reliability degree is calculated based on the vehicle information of the probe vehicles having IDs of 1501 to 1505 using the mathematical expression 1. The calculated reliability degree has a value of 0.07.

FIG. 9C shows an example of vehicle information having IDs of 1601 to 1605. The vehicles having IDs of 1601 to 1605 have high newness degrees because the proximity of the start time of the first lane change to the current time is the same as in the case of FIG. 9A. The vehicles having IDs of 1601 to 1605 travel in the 2-1 travelling patter which does not perform the second lane change. Thus, the probability degree for each of the vehicles is set as 0.30. The reliability degree is calculated based on the vehicle information of the probe vehicles having IDs of 1601 to 1605 using the mathematical expression 1. The calculated reliability degree has a value of 0.27.

In the present embodiment, the product of the probability degree and the newness degree is obtained as the reliability degree. Alternatively, the reliability may be set as the probability degree only, or set as the newness degree only.

(e) Threshold of Reliability Degree

When the reliability degree has a high value, the stopped vehicle is highly like to be existed. When the reliability degree has a low value, the stopped vehicle is less likely to be existed. Thus, a threshold (corresponding to a “first threshold”) may be set in order to determine the presence of the stopped vehicle. For example, when the reliability degree is higher than the threshold, the determination result showing the presence of the stopped vehicle may be transmitted. When the reliability degree is lower than the threshold, the determination result showing the presence of the stopped vehicle may not be transmitted.

For example, the threshold is set to 0.5. In the case shown in FIG. 9A, since the reliability degree is higher than the threshold, the determination result indicating the presence of the stopped vehicle is configured to be transmitted. In the cases shown in FIG. 9B and FIG. 9C, since the reliability degrees are lower than the threshold, the determination result indicating the presence of the stopped vehicle is configured to be not transmitted.

In the present embodiment, the comparing with the threshold is executed by the information processing device 102. Alternatively, the comparing with the threshold may be executed by the CPU 307 (corresponding to “calculation unit”) of the driving assistance device 103. This example will be described in the following second embodiment.

(5) Operation of Information Processing Device

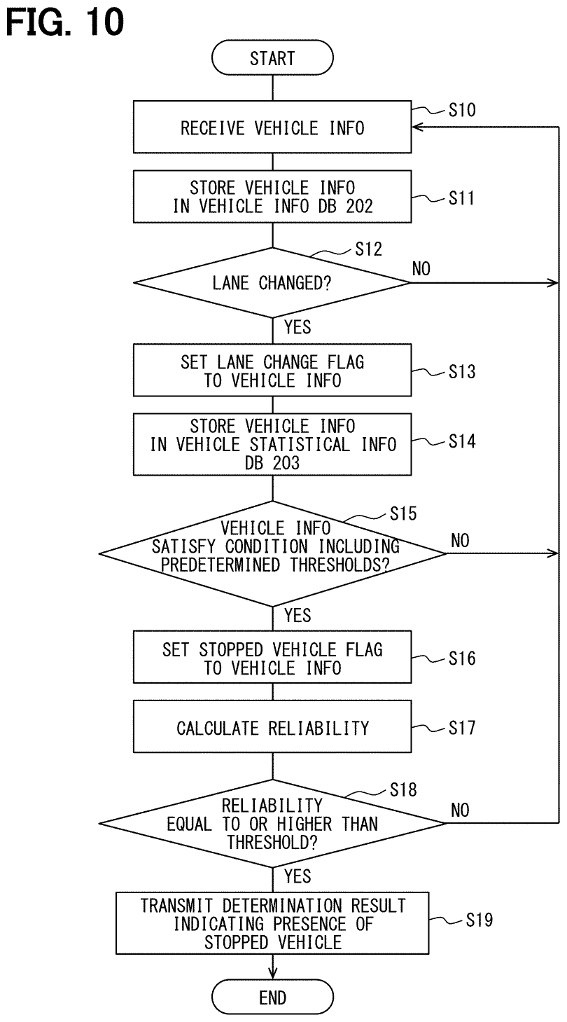

The following will describe an operation of the information processing device 102 with reference to FIG. 10.

In S10, the information processing device 102 receives, by the communication device 204 via the communication network 105, the vehicle information transmitted from the communication device 403 of the probe vehicle 104.

In S11, the information processing device 102 stores the received vehicle information in the vehicle information database 202.

In S12, the information processing device 102 analyzes, using the CPU 205 of the server 201, the vehicle information of the probe vehicle 104, and determines the presence of the lane change.

In S13, the information processing device 102 sets, using the CPU 205, the lane change flag to the vehicle information based on which the presence of lane change is determined.

In S14, the information processing device 102 stores the vehicle information to which the lane change flag is set in the vehicle statistical information database 203.

In S15, the information processing device 102 analyzes, using the CPU 205, the vehicle information to which the lane change flag is set and stored in the vehicle statistical information database 203. Specifically, the information processing device determines whether the lane change is occurred to a certain number of vehicle information records in a certain section in a specific time. That is, the information processing device whether there is vehicle information satisfying the condition including predetermined threshold values set for determining the presence or absence of the stopped vehicle.

In S16, the information processing device 102 sets, using the CPU 205, the stopped vehicle flag to the vehicle information based on which the presence of stopped vehicle is determined.

In S17, the information processing device 102 calculates, using the CPU 205, the reliability degree for the vehicle information to which the stopped vehicle flag is set.

In S18, the information processing device 102 determines, using the CPU 205, whether the reliability degree calculated in S17 is equal to or higher than the threshold.

In S19, in a case where the reliability degree is “equal to or higher” than the threshold, the information processing device 102 transmits, by the communication device 204, the determination result indicating presence of the stopped vehicle to the driving assistance device 103 mounted on the driving assistance target vehicle that follows the probe vehicle.

In a case where the reliability degree is “equal to or lower” than the threshold, the determination result or the reliability degree are not transmitted to the driving assistance device 103.

In the present disclosure, “equal to or higher” includes a case where a reference value is included and also a case where the reference value is not included.

In the present disclosure, “equal to or lower” includes a case where a reference value is included and also a case where the reference value is not included.

(6) Operation of Driving Assistance Device

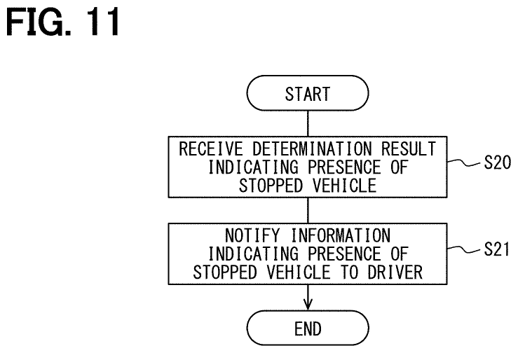

The following will describe an operation of the driving assistance device 103 with reference to FIG. 11.

In S20, the driving assistance device 103 receives, via the communication network 105, the determination result indicating the presence of the stopped vehicle by the communication device 301.

In S21, the driving assistance device 103 notifies a “driver” of the information indicating the presence of the stopped vehicle via an image displayed on the display device 305 or an audio signal output from the speaker 306. In the driving assistance device 103, the notification of the information indicating the presence of the stopped vehicle is controlled by the CPU 307 of the electronic control device 304.

In the present disclosure, the “driver” includes not only a person who is driving but also a person who is in a vehicle compartment without driving.

(7) Conclusion

In the first embodiment, the reliability degree indicating the reliability of the determination result indicating presence or absence of the stopped vehicle. Thus, the following vehicle, which is the driving assistance target vehicle, can more accurately and high-speedily determine the presence or absence of the stopped vehicle when passing the position where the presence of the stopped vehicle is determined.

### Modification Example of First Embodiment

In the above first embodiment, the navigation electronic control device 304 of the navigation device 301 of the driving assistance device 103 notifies the driver of the information indicating the presence of the stopped vehicle via the image displayed on the display device 305 or the audio signal output from the speaker 306 controlled by the CPU 307 of the electronic control device 304. As another example, the driving assistance device 103 may include another electronic control device that controls driving and body of the vehicle.

In this modification example of the first embodiment, the information processing system, the information processing device, and the probe vehicle may have similar configurations to the first embodiment.

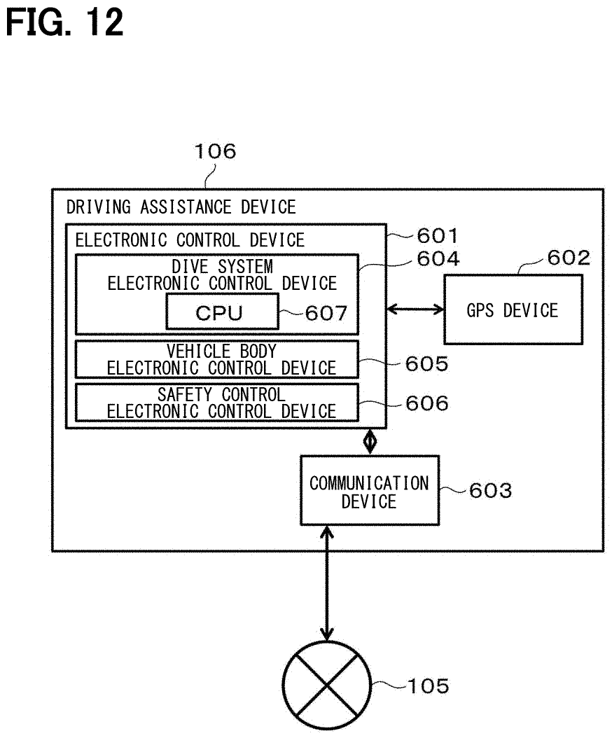

The following will describe a configuration of the driving assistance device including the electronic control device according to the modification example of the first embodiment with reference to FIG. 12. FIG. 12 shows a configuration of the driving assistance device which includes the electronic control device and is mounted on the driving assistance target vehicle. The driving assistance device 106 shown in FIG. 12 includes an electronic control device 601, a GPS device 602, and a communication device 603. The electronic control device 601 may include: a drive system electronic control device 604 that controls an engine, a steering wheel, a brake, etc.; a vehicle body electronic control device 605 that controls a meter, and a power window, etc.; and a safety control electronic control device 606 that controls an avoidance of a collision with an obstacle or a pedestrian. For example, a vehicle mounted computer (not shown in the drawings) may correspond to the drive system electronic control device 604. The drive system electronic control device 604 includes a CPU 607, ROM and RAM (not shown). The vehicle body electronic control device 605 and the safety control electronic control device 606 are similar to the drive system electronic control device. The configuration of the electronic control device 601 is not limited to the above-described example. The electronic control device 601 may also have a function of the navigation device 301. The GPS device 602 and the communication device 603 are similar to the GPS 302 and the communication device 303 of the first embodiment, detailed description thereof will be omitted.

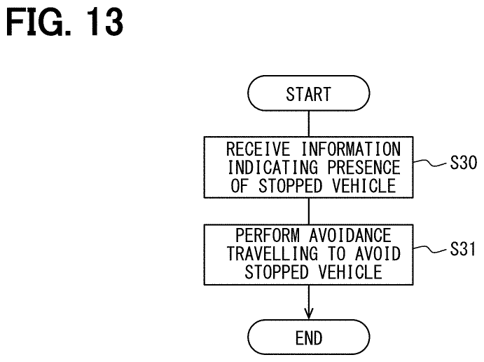

The follow will describe an operation executed by the driving assistance device in the modified example of the first embodiment with reference to FIG. 13. FIG. 13 is a diagram for explaining the operation of the driving assistance device 106.

In S30, the driving assistance device 106 receives, via the communication network 105, the determination result indicating the presence of the stopped vehicle by the communication device 603.

In S31, the driving assistance device 106 uses the CPU 607 of the drive system electronic control device 604 of the electronic control device 601 to perform avoidance driving in order to avoid the stopped vehicle. Specifically, the drive system electronic control device 604 changes the lane before a stop position of stopped vehicle by an automatic steering wheel operation that automatically controls the vehicle to change the lane, and changes the lane after passing the stop position of stopped vehicle as necessary. That is, the drive system electronic control device 604 controls the driving assistance target vehicle, which is the following vehicle, to perform the same driving operation as the probe vehicle 104 which transmits the vehicle information indicating the determination result of the presence or absence of the stopped vehicle.

According to the modification example of the first embodiment, the driving assistance target vehicle, which is the following vehicle, can perform the operation in response to the occurrence of the event by the electronic control device 601, such as the drive system electronic control device 604 which enables the automatic steering wheel operation for automatically changing the lane.

### Second Embodiment

In the first embodiment, the information processing device 102 determines whether the reliability degree is equal to or higher than the predetermined threshold. Alternatively, the driving assistance device 103 mounted on the driving assistance target vehicle, which is the following vehicle, may determine whether the reliability degree is equal to or higher than the predetermined threshold. In this case, the predetermined threshold may be stored in the driving assistance target vehicle, which is the following vehicle.

In second embodiment, the information processing system, the information processing device, the driving assistance device, and the probe vehicle may have similar configurations to the first embodiment.

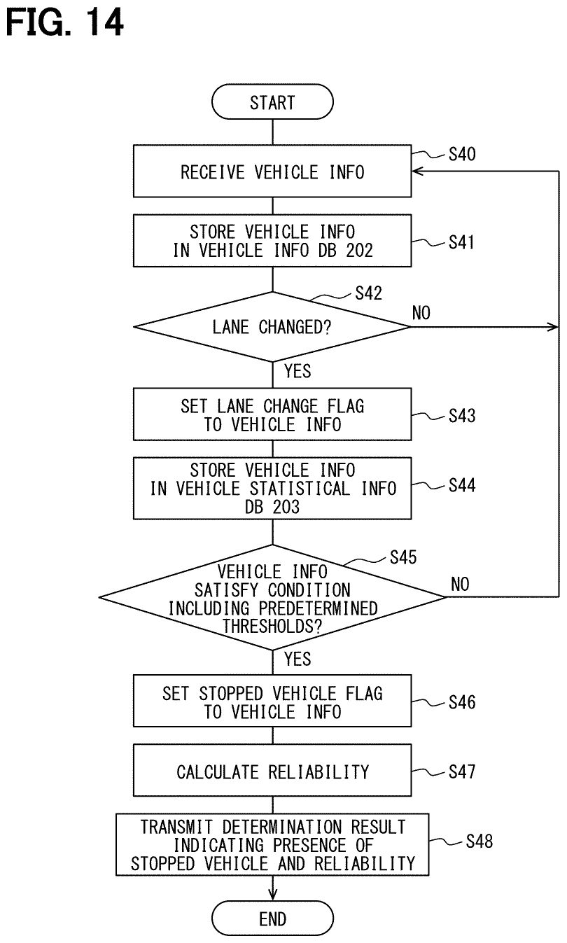

The following will describe an operation of the information processing device 102 with reference to FIG. 14. Since process executed in S40 to S47 are similar to the process executed in S10 to 17 of the first embodiment, detailed description thereof will be omitted.

In S48, the information processing device 102 transmits, by the communication device 204, the determination result indicating presence or absence of the stopped vehicle and the reliability degree to the driving assistance device 103 mounted on the driving assistance target vehicle that follows the probe vehicle.

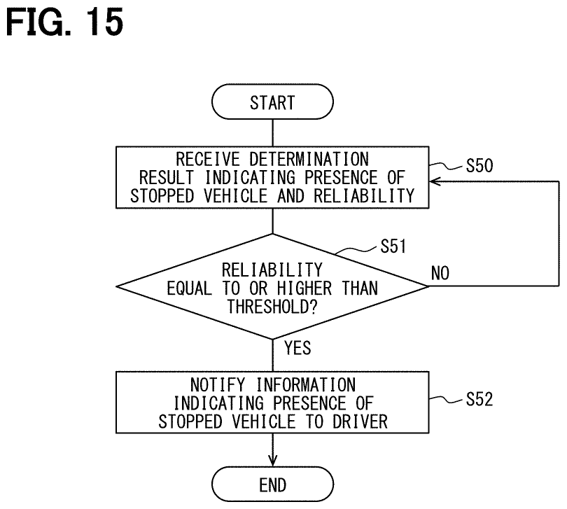

The following will describe an operation of the driving assistance device 103 with reference to FIG. 15.

In S50, the driving assistance device 103 receives, via the communication network 105, the determination result indicating presence or absence of the stopped vehicle and the reliability degree by the communication device 303.

In S51, the CPU 307 of the navigation device 304 of the driving assistance device 103 determines whether the received reliability degree is equal to or higher than the threshold.

In S52, the driving assistance device 103 notifies, in response to the reliability degree being equal to or higher than the threshold, the information indicating the presence of the stopped vehicle via the image displayed on the display device 305 or the audio signal output from the speaker 306.

When the reliability degree is equal to or lower than the threshold value, the determination result is not notified to the driver.

In the second embodiment, the setting of the reliability degree is executed by the driving assistance target vehicle, which is the following vehicle. Thus, the driving assistance target vehicle can execute an operation in response to the presence of the stopped vehicle.

### Third Embodiment

In the first embodiment, at least one of the angular velocity, the azimuth angel of the steering wheel, the speed information, or the position information of the probe vehicle 104 is used, as the vehicle information, to determine the presence or absence of the lane change, to determine the presence or absence of the stopped vehicle, and to calculate the reliability degree. Alternatively, the probe vehicle may further acquire image information, and uses the image information, as the vehicle information, when determining the presence or absence of the lane change, determining the presence or absence of the stopped vehicle, and calculating the reliability degree.

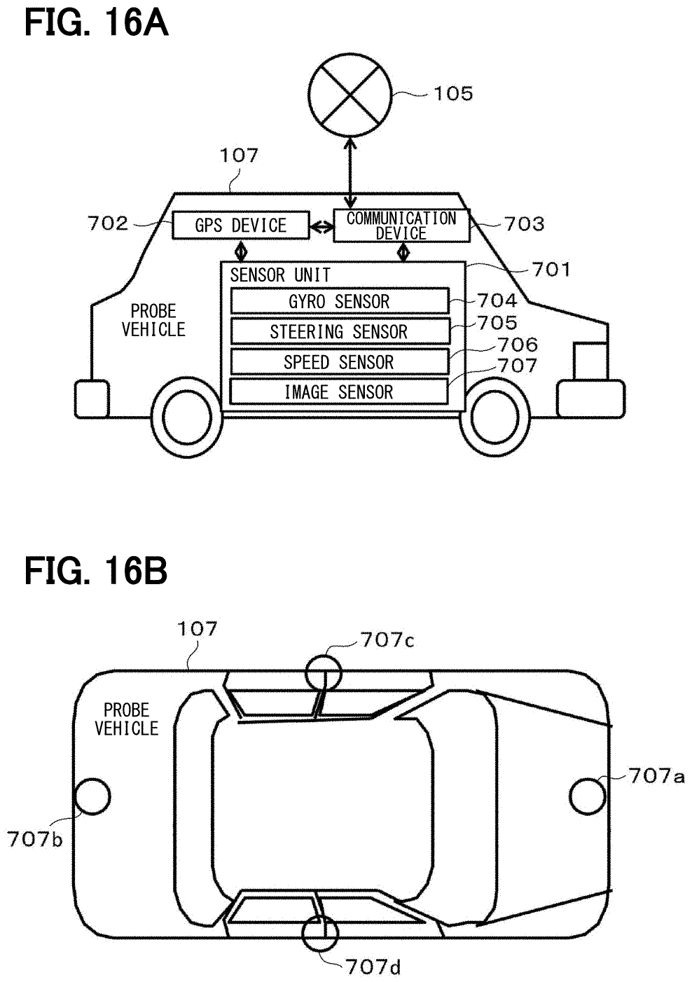

The configuration of the probe vehicle according to the third embodiment will be described with reference to FIG. 16A and FIG. 16B. FIG. 16A shows a configuration of a probe vehicle that acquires vehicle information. The probe vehicle 107 shown in FIG. 16A includes a sensor unit 701, a GPS device 702, and a communication device 703. The sensor unit 701 includes a gyro sensor 704, a steering sensor 705, a speed sensor 706, and an image sensor 707. The image sensor 707 may be provided by CCD, CMOS, organic quantum dots, and compounds. In addition to the sensor capable of detecting visible light, an infrared sensor capable of detecting infrared light may be used as the image sensor. The sensor unit 701 may include a LIDAR (Light Imaging Detection and Ranging) and a millimeter wave radar, each of which includes a light emitting unit and a light receiving unit, and can analyze a distance between the stopped vehicle and the probe vehicle 107 and properties of the stopped vehicle. The LIDAR or millimeter wave radar may adopt a phase difference detection method that enables a distance measurement between the stopped vehicle and the probe vehicle 107 by a phase difference between an emission light emitted toward the stopped vehicle and a reflection light reflected on the stopped vehicle. The LIDAR or millimeter wave radar may adopt a ToF (Time of Flight) method that enables a distance measurement between the stopped vehicle and the probe vehicle 107 based on the duration until the reflection light reflected on the stopped vehicle is received by the probe vehicle 107. The LIDAR or millimeter wave radar may adopt a triangular ranging method that enables a distance measurement between the stopped vehicle and the probe vehicle 107 based on a position at which the positioning sensor receives the reflection light reflected on the stopped vehicle. The position is detected by the position sensor. The GPS 702 and the communication device 703 are similar to the GPS 402 and the communication device 403 of the first embodiment, detailed description thereof will be omitted.

Further, as shown in FIG. 16B, the image sensor 707 may include an image sensor 707a installed at a front portion of the probe vehicle 107, an image sensor 707b installed at a rear portion of the probe vehicle 107, an image sensor 707c installed at a left portion of the probe vehicle 107, and an image sensor 707d installed at a right portion of the probe vehicle 107. The image sensor 707 may be installed at an upper portion of the probe vehicle 107 under a condition that image information surrounding the probe vehicle 107 is acquired.

The following will describe the vehicle information obtained by the probe vehicle in the third embodiment.

The probe vehicle 107 acquires various vehicle information using various sensors of the sensor unit 701 and the GPS device 702, which are mounted on the probe vehicle 107. The various vehicle information acquired by the gyro sensor 704, the steering sensor 705, and the speed sensor 706 are similar to the various vehicle information acquired by the gyro sensor 404, the steering sensor 405, and the speed sensor 406 in the first embodiment, and detailed description thereof will be omitted. The position information acquired by the GPS device 702 is similar to the position information acquired by the GPS device 402 in the first embodiment, and detailed description thereof will be omitted.

During the travelling of the probe vehicle 107, the image sensor 707 acquires image information capable of recognizing a road condition including the presence or absence of the stopped vehicle in a front area, a rear area, a left area, and a right area around the vehicle body of the probe vehicle 107. For example, in the image sensor 707, when the probe vehicle 107 avoids the stopped vehicle, the front image sensor 707a acquires image information of the stopped vehicle before the first lane change, the image sensor 707c installed at left portion of the probe vehicle acquires the image information of the stopped vehicle after the first lane change, the image sensor 707b installed at rear portion of the probe vehicle acquires the image information of the stopped vehicle after the second lane change.

The following will describe a calculation method of the reliability degree of the determination result indicating the presence of the stopped vehicle with use of the image information as the vehicle information. In the present embodiment, the calculation of the reliability degree is carried out by the information processing device 102. The determination of the presence or absence of the stopped vehicle in the present embodiment is similar to the determination method described in the first embodiment. In the present embodiment, the probability degree for calculating the reliability degree is calculated by the following mathematical expression 4.

Rᵢ=Sᵢ·Gᵢ·P (Mathematical expression 4)

Herein, Ri represents the probability degree, Si represents the evaluation value determined by the traveling pattern, Gi represents the evaluation value determined by the presence or absence of the image information, and P represents a probability of over detection of the image information.

The parameter Gi is set to 0.9 when the image sensor 707 detects the stopped vehicle, and is set to 0.1 when the image sensor 707 does not detect the stopped vehicle.

The parameter Gi is not limited to this example, and can be changed as appropriate.

The parameter P is determined based on at least one of the weather, climate, temperature, road surface condition, or vehicle function, which are obtained during the travelling of the probe vehicle.

According to the third embodiment, the image information is used in the calculation of the reliability degree. Thus, the determination of presence or absence of the stopped vehicle can be more accurately and high-speedily determined.

### Fourth Embodiment

In the first embodiment, a presence of obstacle is described as an event. Specifically, a presence of stopped vehicle is described as the event. In the present embodiment, a presence of wrong way travelling vehicle is determined as an event, and the determination result indicating the presence of wrong way travelling vehicle is notified to the driving assistance target vehicle that follows the probe vehicle.

The determination of presence or absence of the wrong way travelling vehicle is made based on the vehicle information indicating a lane change made by a sharp turning of steering wheel in the probe vehicle. The threshold values of the specific time, the certain section, and the certain number of probe vehicles 104 that change the lane for determining the presence or absence of the wrong way travelling vehicle may be properly set. For example, the threshold number of probe vehicles may be set to 2. This threshold number is calculated based on a probability of 0.10 which indicates the travelling vehicle on the road is a probe vehicle, a travelling frequency of 2.5 vehicles per minute usually travelling on the road, and an average time of the occurrence of the wrong way travelling which is set to 8 minutes. For example, the threshold value of the section may be set to 10 km, and the threshold value of the specific time may be set to 8 minutes.

When the vehicle information acquired from the two vehicles indicate the presence of the wrong way travelling vehicle, the reliability degree is calculated based on the vehicle information. When the calculated reliability degree is equal to or higher than the threshold value, the determination result indicating presence of the wrong way travelling vehicle and the reliability degree are transmitted to the driving assistance device 103.

In the present embodiment, the probe vehicle in the present embodiment may be configured to acquire the image information similar to the probe vehicle 107 according to the third embodiment. In the determination of presence of wrong way travelling vehicle, the image information of the wrong way travelling vehicle may be used in addition to the lane change made by a sharp turning of the steering wheel.

According to the fourth embodiment, the driving assistance target vehicle which is the following vehicle can accurately and high-speedily determine the presence of the wrong way traveling vehicle when passing the position where the presence of the wrong way travelling vehicle is determined.

### Fifth Embodiment

In the present embodiment, a presence of traffic congestion is determined as an event, and the determination result indicating the presence of traffic congestion is notified to the driving assistance target vehicle that follows the probe vehicle.

When determining the presence or absence of traffic congestion, slow driving is determined instead of the lane change based on the vehicle information of the probe vehicle 104. The threshold values of the specific time, the certain section, and the certain number of probe vehicles 104 that performs the slow driving for determining the presence or absence of the traffic congestion may be properly set. For example, the threshold number of probe vehicles may be set to 10. This threshold number is calculated based on a probability of 0.50 which indicates the travelling vehicle on the road is a probe vehicle, a travelling frequency of 2 vehicles per minute usually travelling on the road, and an average time period of the traffic congestion which is set to 10 minutes. For example, the threshold value of the section may be set to 300 meters, and the threshold value of the specific time period may be set to 10 minutes.

When the vehicle information acquired from the ten vehicles indicate the presence of the traffic congestion, the reliability degree is calculated based on the vehicle information. When the calculated reliability degree is equal to or higher than the threshold value, the determination result indicating presence of the traffic congestion and the reliability degree are transmitted to the driving assistance device 103.

According to the fifth embodiment, the driving assistance target vehicle which is the following vehicle can accurately and high-speedily determine the presence of the traffic congestion when travelling toward the position where the presence of traffic congestion is determined.

### CONCLUSION

The information processing device and the driving assistance device according to the embodiments of the present disclosure are described above.

Terms used in the description of each embodiment are examples and may be replaced with synonymous terms or terms having a synonymous function.

The block diagram used in the description of each embodiment is a diagram in which the configurations of the information processing device and the like are classified and organized corresponding to the functions. These functional blocks are realized by any combination of hardware or software. Further, since the functions are shown, the block diagram can be understood as disclosure of the method, program, or program product that implements the method.

Order of functional blocks that can be grasped as processing, a sequence, and a method described in relation to each embodiment may be changed unless some restriction is imposed, for example, a result from one step is utilized at another step.

The terms of “first” and “second” used in the description of each embodiment are for discriminating two or more configurations and methods of the same kind and do not limit order or superiority or inferiority.

In each embodiment, the driving assistance device and the information processing system are described as vehicle use purpose devices. The present disclosure also includes an information processing system that includes a dedicated purpose information processing device other than vehicle use purpose and a general purpose information processing device other than vehicle use purpose. The present disclosure may also include an information processing system that includes a dedicated purpose driving assistance device other than vehicle use purpose and a general purpose driving assistance device other than vehicle use purpose.

The present disclosure is implemented not only by dedicated hardware having a configuration and a function described in relation to each embodiment. The present disclosure can also be implemented as a combination of a program for implementing the present disclosure, recorded on such a recording medium as memory and a hard disk and general-purpose hardware including dedicated or general-purpose CPU, memory, or the like, capable of executing the program.

A program may be stored, as a program product, in a non-transitory tangible storage medium including an external storage (e.g., hard disk, USB memory, CD/BD), or an internal storage (e.g., RAM, ROM) in a special-purpose or general-purpose hardware (e.g., computer). Such a program may be downloaded to the storage medium in the hardware via a communication link from a server. Consequently, when the program is upgraded, the latest function is always provided.

The driving assistance device according to the present disclosure has been described mainly as a vehicle use purpose driving assistance device mounted on a vehicle. The driving assistance device may also be applied to general moving bodies such as motorcycles, bicycles with electric motors, railways, ships, and aircrafts.

What is claimed is:

1. An information processing device communicating with a driving assistance device mounted on a driving assistance target vehicle, the information processing device comprising:
a reception unit configured to receive, from a probe vehicle, vehicle information acquired by the probe vehicle;
a determination unit configured to determine a presence or absence of an occurrence of an event based on the vehicle information;
a calculation unit configured to calculate a reliability degree indicating a reliability level of a determination result determined by the determination unit; and
a transmission unit configured to transmit, to the driving assistance device, the determination result and the reliability degree.

2. The information processing device according to claim 1, wherein
the calculation unit further determines whether the reliability degree is equal to or higher than a predetermined first threshold,
the transmission unit transmits, to the driving assistance device, the determination result without the reliability degree in a case where the reliability degree is equal to or higher than the first threshold, and
the transmission unit cancels a transmission of, to the driving assistance device, the determination result and the reliability degree in a case where the reliability degree is lower than the first threshold.

3. The information processing device according to claim 1, wherein
the reception unit receives, from the probe vehicle, as the vehicle information, at least one of a position of the probe vehicle corresponding to a specific time, an angular velocity of the probe vehicle corresponding to the specific time, an azimuth angle of a steering wheel of the probe vehicle corresponding to the specific time, or a speed of the probe vehicle corresponding to the specific time.

4. The information processing device according to claim 1, wherein
the determination unit determines the occurrence of the event based on the vehicle information which satisfies a condition defining a predetermined second threshold.

5. The information processing device according to claim 4, wherein,
in a case where the occurrence of the event corresponds to a presence of an obstacle, the determination unit determines the occurrence of the event based on a duration of the event, position information of the event, and a quantity of the probe vehicles, which are individually set for the event.

6. The information processing device according to claim 1, wherein,
in a case where the occurrence of the event corresponds to a presence of an obstacle, the determination unit determines, based on the vehicle information, a presence or absence of a lane change performed by the probe vehicle to determine the presence of the obstacle.

7. The information processing device according to claim 1, wherein,
the calculation unit calculates the reliability degree based on a product obtained by multiplying a probability degree of the vehicle information with a newness degree of the vehicle information.

8. The information processing device according to claim 1, wherein
the calculation unit calculates the reliability degree based on multiple records of the vehicle information acquired from multiple probe vehicles,
the calculation unit calculates the reliability degree using a mathematical expression 1 and a mathematical expression 2 as follows based on a newness degree of each vehicle information and a probability degree of each vehicle information, and
$$\begin{matrix}C = \frac{{\sum }_{i = 1}^{n} {R}_{i} \cdot {F}_{i}}{n} \times 1 \; 00 [ \% ] & ( Mathematical expression 1 ) \\ C = {\sum }_{i = 1}^{n} {R}_{i} \cdot {F}_{i} & ( Mathematical expression 2 )\end{matrix}$$
herein,
C: Reliability degree
Ri: Probability degree
Fi: Newness degree
i: Identification number of vehicle information
n: Quantity of probe vehicles.

9. The information processing device according to claim 8, wherein
the probability degree is specified based on an evaluation value determined according to a travelling pattern of each probe vehicle.

10. The information processing device according to claim 9, wherein,
in a case where the occurrence of the event corresponds to a presence of an obstacle, a lane change of the probe vehicle from a first lane to a second lane is defined as a first lane change, and a lane change of the probe vehicle from the second lane to the first lane after an execution of the first lane change is defined as a second lane change,
the evaluation value is determined according to a presence or absence of the second lane change.

11. The information processing device according to claim 8, wherein
the calculation unit calculates the newness degree using the following mathematical expression 3, and
$${F}_{i} = 1 - \frac{{t}_{i}}{M} \qquad ( Mathematical expression 3 )$$
herein
Fi: Newness degree
i: Identification number of vehicle information
ti: Duration from a start time of the event to a current time
M: Event duration set for each event.

12. A driving assistance device mounted on a driving assistance target vehicle and communicating with an information processing device,
wherein the information processing device includes:
a reception unit configured to receive, from a probe vehicle, vehicle information acquired by the probe vehicle;
a determination unit configured to determine a presence or absence of an occurrence of an event based on the vehicle information;
a calculation unit configured to calculate a reliability degree indicating a reliability level of a determination result determined by the determination unit; and
a transmission unit configured to transmit the determination result and the reliability degree to the driving assistance device,
the driving assistance device comprising:
a reception unit configured to receive the determination result and the reliability degree transmitted from the information processing device;
a calculation unit configured to determine whether the reliability degree is equal to or higher than a predetermined first threshold; and
a notification unit configured to notify the occurrence of the event to a driver of the driving assistance target vehicle in a case where the reliability degree is determined to be equal to or higher than the first threshold.

13. A program product stored in a computer readable non-transitory tangible medium and executed by an information processing device, wherein the information processing device communicates with a driving assistance device mounted on a driving assistance target vehicle,
the program product comprising instructions for:
receiving, from a probe vehicle, vehicle information acquired by the probe vehicle;
determining an event occurrence based on the vehicle information;
calculating a reliability degree indicating a reliability level of a determination result of the event occurrence; and
transmitting the determination result and the reliability degree to the driving assistance device.

14. A program product stored in a computer readable non-transitory tangible medium and executed by a driving assistance device, the driving assistance device being mounted on a driving assistance target vehicle and communicating with an information processing device,
wherein the information processing device includes:
a reception unit configured to receive, from a probe vehicle, vehicle information acquired by the probe vehicle;
a determination unit configured to determine a presence or absence of an occurrence of an event based on the vehicle information;
a calculation unit configured to calculate a reliability degree indicating a reliability level of a determination result determined by the determination unit; and
a transmission unit configured to transmit the determination result and the reliability degree to the driving assistance device,
the program product comprising instructions for:
receiving the determination result and the reliability degree transmitted from the information processing device;
determining whether the reliability degree is equal to or higher than a predetermined first threshold; and
notifying the occurrence of the event to a driver of the driving assistance target vehicle in a case where the reliability degree is equal to or higher than the first threshold.
